(19) United States
(12) Patent Application Publication
(10) Pub. No.: US 2018/0183988 A1
(43) Pub. Date: Jun. 28, 2018

(54) IMAGE PROCESSING DEVICE, IMAGE PROCESSING METHOD, IMAGING DEVICE, AND STORAGE MEDIUM

(71) Applicant: CANON KABUSHIKI KAISHA, Tokyo (JP)

(72) Inventor: Yukiko Uno, Tokyo (JP)

(21) Appl. No.: 15/850,133

(22) Filed: Dec. 21, 2017

(30) Foreign Application Priority Data
Dec. 27, 2016 (JP) 2016-253249

(51) Int. Cl. H04N 5/235; H04N 5/232

(52) U.S. Cl. CPC H04N 5/2355; H04N 5/23216; H04N 5/2356

(57) ABSTRACT

An image processing device acquires a plurality of image data each having a different viewpoint acquired from one instance of photographing and performs image processing. The plurality of image data each having a different viewpoint is image data output from a plurality of photoelectric conversion units which respectively receive light passing through different pupil areas of an imaging optical system by an imaging device. An image processing unit performs high dynamic range (HDR) combining processing on a plurality of image data each having a different viewpoint which is input image data and generates output image data. When combined output image data is recorded as a file in a storage medium, a control unit performs processing to save it in the same file format as a file format of input image data.

### BACKGROUND OF THE INVENTION

### Field of the Invention

The present invention relates to an image processing technology for performing dynamic range extension processing using a plurality of image data each having a different viewpoint.

### Description of the Related Art

There is a technology of extending a dynamic range (hereinafter, referred to as DR) by combining a plurality of images. In an imaging device and the like, there is a method of generating a high dynamic range (HDR) image without overexposure or underexposure and saving the image as a file. Japanese Patent Laid-Open No. 2013-251724 discloses a technology which is capable of recording image data after HDR combination and values of pixels before the combination, which are changed between before and after the combination, as additional information in a file, and correcting an area with an unnatural combined result later. In addition, in Japanese Patent Laid-Open No. 2014-160912, an HDR image is acquired by using and combining a plurality of light field images formed of a plurality of viewpoint images. A pixel value which is not used in combination is replaced with a specific value at the time of saving a file, and a file can be compressed and saved with high efficiency.

In addition, Japanese Patent Laid-Open No. 2016-58993 discloses a technology of combining an HDR image using pupil-divided images. Specifically, an imaging element which shares a single microlens and receives light passing through pupil areas with different optical systems is used. From a first pixel and a second pixel, it is possible to generate an HDR image by combining image data obtained from one pixel and image data obtained by adding values of the first pixel and the second pixel according to the brightness of a subject.

However, a technology capable of saving data of an HDR image combined using pupil-divided images as a file in a format in accordance with a purpose of use of a user has not been proposed.

### SUMMARY OF THE INVENTION

The present invention provides an image processing device and an image processing method which can save an image combined using a multi-viewpoint image in a storage medium in a predetermined file format.

An image processing device according to the first embodiment of the present invention includes a memory storing instructions and a processor which is capable of executing the instructions causing the image processing device to: acquire a plurality of image data each having a different viewpoint as input image data; perform combining processing related to dynamic range extension on the input image data and generate output image data; and save the output image data or the viewpoint image data and the output image data in a predetermined file format as a file in a storage medium.

Further features of the present invention will become apparent from the following description of exemplary embodiments (with reference to the attached drawings).

### BRIEF DESCRIPTION OF THE DRAWINGS

FIGS. 1A and 1B are diagrams which show a configuration of a device according to an embodiment of the present invention.

FIG. 2 is a diagram which shows a screen configuration example of a user interface in a first embodiment.

FIG. 3 is a diagram which shows a data structure of a RAW image file in the first embodiment.

FIG. 4 is a flowchart which describes image processing of the first embodiment.

FIG. 5 is a flowchart which describes image reading processing of the first embodiment.

FIG. 6 is a diagram which indicates a relationship between pixel values in HDR combination processing of the first embodiment.

FIG. 7 is a flowchart which describes the HDR combination processing of the first embodiment.

FIG. 8 is a flowchart which describes a file saving processing procedure of the first embodiment.

FIG. 9 is a diagram which shows a structure of a HDR combined RAW image file of a second embodiment.

FIG. 10 is a flowchart which describes image processing of the second embodiment.

FIG. 11 is a flowchart which describes image reading processing of the second embodiment.

FIGS. 12A and 12B are diagrams which describe a file selection method of the second embodiment.

FIG. 13 is a flowchart which describes file save processing of the second embodiment.

FIG. 14 is a flowchart which describes processing subsequent to FIG. 13.

FIGS. 15A to 15C are diagrams which describe difference image data and image compression processing of the second embodiment.

FIG. 16 is a diagram which shows a data structure of a RAW image file of a third embodiment.

FIG. 17 is a flowchart which describes image processing of the third embodiment.

FIG. 18 is a flowchart which describes file format selection processing of the third embodiment.

FIG. 19 is a flowchart which describes file save processing of the third embodiment.

FIG. 20 is a flowchart which describes processing subsequent to FIG. 19.

### DESCRIPTION OF THE EMBODIMENTS

Hereinafter, each embodiment of the present invention will be described in detail with reference to drawings.

### First Embodiment

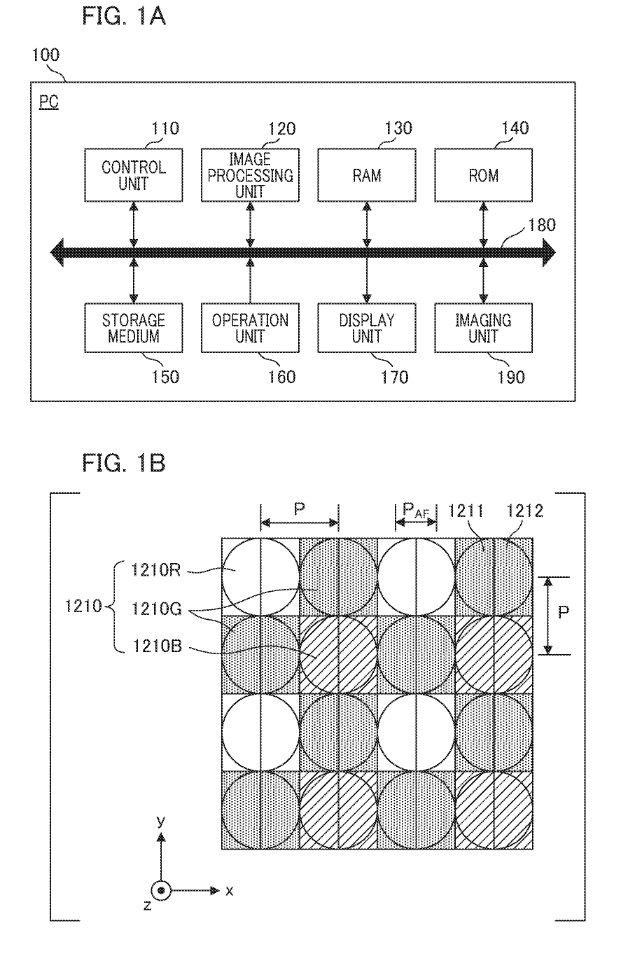

In the present embodiment, an example of an image processing device which can save image data before combining processing of dynamic range extension and combination parameters in a file is shown. FIG. 1A is a block diagram which shows a configuration example of a personal computer (hereinafter, referred to as PC) 100 in the present embodiment.

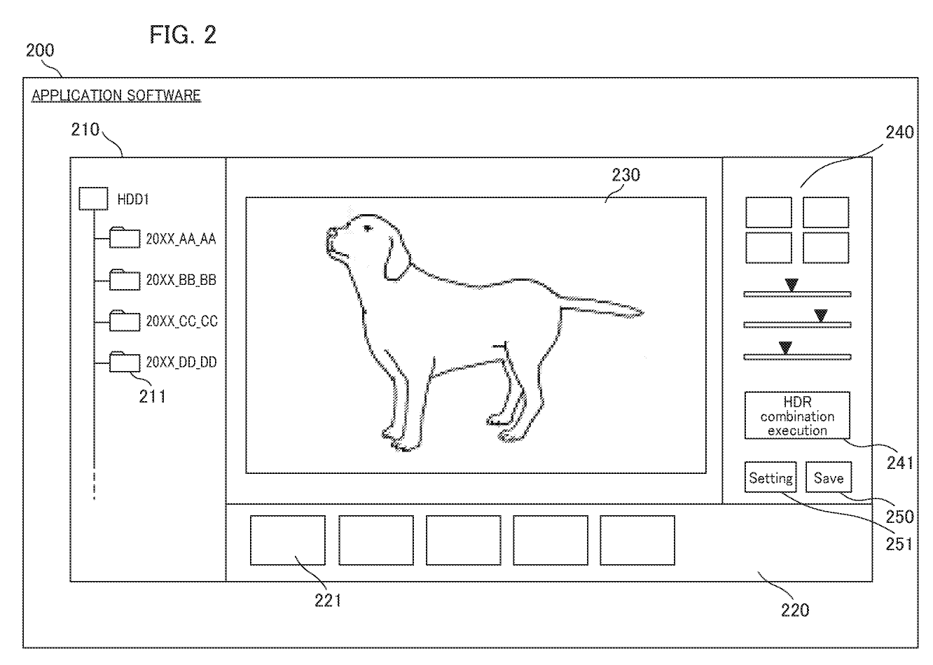

A control unit 110 includes, for example, a central processing unit (CPU) which is a central unit for controlling the entire PC 100. An image processing unit 120 performs HDR combination processing using input image data. The HDR combination processing will be described below. A memory 130 is a random access memory (RAM) which temporarily stores a program or data supplied from the outside. A memory 130 is used as a temporary storage area for data output in accordance with execution of a program. A read only memory (ROM) 140 is a storage device which stores a program or parameters. The ROM 140 in the present embodiment stores a program code for software executed by the control unit 110, such as an application 200 (refer to FIG. 2), parameters necessary for operation of the application 200, and the like. The ROM 140 is, for example, a flash ROM, and a control program can be rewritten therein.

A storage medium 150 can be read and written by a computer. For example, a built-in memory included in a computer, a memory card detachably connected to the computer, a medium capable of recording electronic data such as a HDD, a CD-ROM, an MO disk, an optical disc, a magneto-optical disc, and the like can be used. Digital data such as image data is stored as a file in the storage medium 150.

The operation unit 160 is constituted by a keyboard, a pointing device, and the like. A user performs an operation instruction for the PC 100 using the operation unit 160 to enable designation of input and output data, change of a program, execution of image processing, and the like.

A display unit 170 includes a display device such as a liquid crystal display and the like. A graphical user interface (GUI) screen of the application 200, a result of image processing, and the like are displayed on a screen of the display unit 170 for example. An internal bus 180 is a transmission path of control signals or data signals between respective elements in the PC 100. If the PC 100 has an imaging function, the PC 100 includes an imaging unit 190. The imaging unit 190 includes an imaging optical system having optical members such as a lens or an aperture, and an imaging element which photoelectrically converts an optical image formed through the imaging optical system. The control unit 110 and the image processing unit 120 perform image processing such as development on image data acquired from the imaging unit 190.

FIG. 1B is a diagram, which schematically shows an arrangement example of pixels in a pupil division type imaging element. A direction perpendicular to a page of FIG. 1B is defined as a z direction, a horizontal direction (lateral direction) orthogonal to the z direction is defined as an x direction, and a vertical direction (longitudinal direction) orthogonal to the x direction and the z direction is defined as a y direction. FIG. 1B representatively shows an area in which four pixels are arranged in the x direction and four pixels are arranged in the y direction. The pupil division-type imaging element can divide a pupil area of the imaging optical system in a pupil division direction, and generate a plurality of image signals from a signal based on a light flux having passed through different pupil portion areas. Specifically, a photoelectric conversion unit of each pixel is divided into two in a horizontal direction (pupil division direction), and each photoelectric conversion unit functions as a sub-pixel unit. In FIG. 1B, an area in which sub-pixel units are arranged over eight pixels in the x direction and four pixels in the y direction is illustrated.

A pixel group 1210 of two rows and two columns in an upper left of FIG. 1B corresponds to a repeating unit of a color filter of a primary color Bayer array provided in the imaging element. Accordingly, a pixel 1210R having a spectral sensitivity of R (red) is disposed at the upper left, a pixel 1210G having a spectral sensitivity of G (green) is disposed at the upper right and the lower left, and a pixel 1210B having a spectral sensitivity of B (blue) is disposed at the lower right. In addition, as representatively shown in the pixel at the upper right of FIG. 1B, each pixel has a photoelectric conversion unit divided into two in the x direction, the photoelectric conversion unit in a left half can serve as a first sub-pixel unit 1211, and the photoelectric conversion unit in a right half can serve as a second sub-pixel unit 1212. One image obtained by acquiring an output of the sub-pixel unit 1211 and one image obtained by acquiring an output of the sub-pixel unit 1212 constitute a pair of viewpoint images. Therefore, it is possible to generate two viewpoint images from one instance of photographing. In addition, signals obtained by the first sub-pixel unit 1211 and the second sub-pixel unit 1212 of each pixel are added, and thereby an added signal can be used as a pixel signal of one normal pixel which is not subjected to pupil division. In the present embodiment, a circuit of each pixel corresponding to each microlens is configured to include a common charge accumulation portion (floating diffusion portion, FD portion) in a plurality of photoelectric conversion units which are pupil-divided. By controlling a transfer of charge to the FD portion and resetting of charge of the FD portion, a pixel signal based on a charge from each sub-pixel unit and a pixel signal output by mixing charge from each sub-pixel unit can be output. For example, it is possible to acquire an A image and a B image as optical images based on a light flux having passed through different pupil portion areas incident on each sub-pixel unit, and an (A+B) image having a signal obtained by mixing signals from each sub-pixel unit. A photoelectric conversion unit in each pixel can be subjected to arbitrary division such as four division, nine division, and the like.

FIG. 2 shows an example of a user interface (UI) screen displayed on the screen of the display unit 170 by the application 200. A display area 210 of a folder is a folder tree display area for displaying a list of files read from the storage medium 150 using a folder tree structure. Display processing to represent a single folder with an icon 211 is performed. A user can select a folder containing an image file which is subjected to image processing by clicking the icon 211. A thumbnail display area 220 is an area for displaying a list of image files saved in a folder selected in the folder tree display area 210. The thumbnail image 221 is an image representing a reduced image corresponding to a single image file. A user can select an image file which is subjected to image processing by clicking the thumbnail image 221. A preview area 230 is an area for displaying a result of performing image processing on an input image file selected by a user.

An editing operation area 240 is an area constituted by a GUI group for a user to perform an image editing operation. The GUI group is, for example, objects which are buttons, sliders, check boxes, or numerical value input boxes. A user can perform an editing operation instruction assigned to the GUI by operating each GUI object of the editing operation area 240. An editing operation is, for example, image rotation, trimming, brightness adjustment, contrast adjustment, white balance adjustment, and noise removal. An HDR combination processing button 241 is a button for a user to click to instruct execution of HDR combination processing. The save processing button 250 is a button for a user to instruct saving of an editing result for an input image file. A setting button 251 is a button for a user to set the operation of the application 200. In addition, the application 200 has a general menu operation unit as an image processing application, but this is not shown.

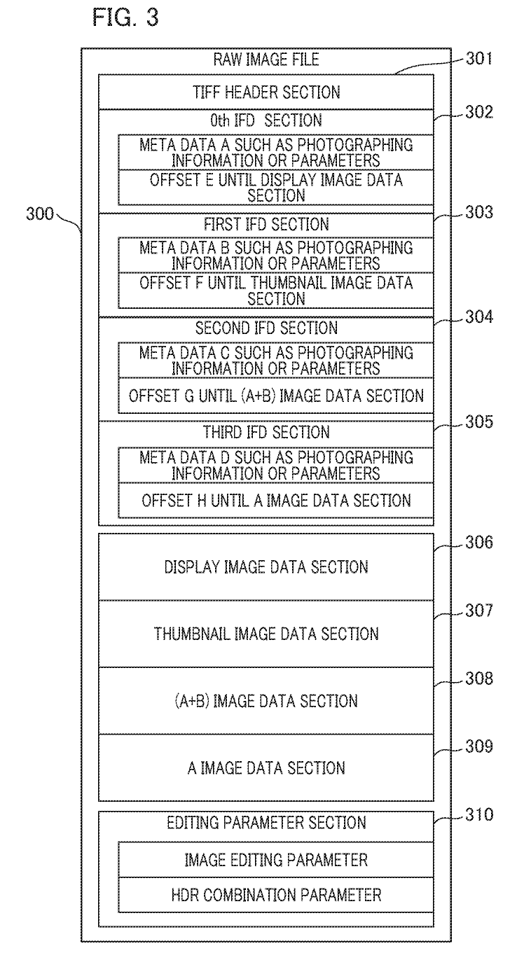

FIG. 3 is a conceptual diagram which shows a data structure of the RAW image file 300 stored in the storage medium 150. RAW images are images which have not been subjected to image processing such as development processing. In the present embodiment, a structure of an image file conforming to a tagged image file format (TIFF) format will be described as an example of a file format corresponding to a multi-page file storing a plurality of pages of image data in one file.

A TIFF header section 301 of the RAW image file 300 is an area in which data for identifying a structure of a TIFF format file, an offset to a first IFD section, and the like are stored.

The following data is stored in each of the IFD sections 302 to 305.

Meta data A to D such as photographing information or parameters related to each piece of image data stored in image data sections 306 to 309.

Offset values E to H of the image data sections 306 to 309.

An offset value of a next IFD section.

In the IFD section positioned last, a specific offset value indicating that there is no next IFD section is stored. In addition, the IFD sections 302 to 305 include a size (the number of pixels in the vertical and horizontal directions) of image data stored in a corresponding image data section, information indicating whether an image is a reduced image, and information on a pupil-divided image to be described below in the metadata A to D, Accordingly, an image processing device performing processing using the RAW image file 300 can read appropriate image data according to a purpose from a plurality of pieces of image data by referring to the IFD sections 302 to 305.

The image data sections 306 to 309 are configured as a display image data section 306, a thumbnail image data section 307, an (A+B) image data section 308, and an A image data section 309. The display image data section 306 is an area for storing a display image to be displayed on a display unit 170 and the like. In the present embodiment, a data format of the display image is set to the joint photographic coding experts group (JPEG) format. The thumbnail image data section 307 is an area for storing a thumbnail image to be used in a display in the thumbnail display area 220 of the application 200 and the like. The thumbnail image is an image reduced by data thinning-out processing and the like of a display image. The (A+B) image data section 308 and the A image data section 309 are areas for storing RAW image data recorded by an imaging device capable of acquiring a pupil-divided image. Specifically, data is recorded by the following method.

The imaging device has an imaging element such as a charge-coupled device (CCD) type image sensor or a complementary metal oxide semiconductor (CMOS) type image sensor. Each of a plurality of main pixels constituting the imaging element is disposed under a single microlens, and has a first pixel and a second pixel which share a single microlens and receive light passing through different pupil areas of an imaging optical system. Optical images received by the imaging element are subjected to photoelectric conversion and A (analog)/D (digital) conversion, and a pupil-divided image (A image) of the first pixel and a pupil-divided image (B image) of the second pixel are generated. The A image and the B image are viewpoint images having different viewpoints. Since the A image and the B image have different pupil intensity distributions and shading characteristics, shading correction is performed using inverse characteristics thereof. By this correction, it is possible to correct uneven brightness caused by uneven vignetting amounts of divided pupils. The imaging device performs processing of recording A image data after shading-correction in the A image data section 309 of the RAW image file 300. In addition, the imaging device performs processing of recording (A+B) image data obtained by adding the A image to the B image in the (A+B) image data section 308. At this time, since the A image has a pixel aperture in an under-exposure state by one stage with respect to the (A+B) image, the (A+B) image is an appropriately exposed image and the A image is an underexposed image. Instead of the A image, the B image may also be recorded as an underexposed image in the RAW image file 300. In addition, bit depths of the (A+B) image and the A image are set to 14 bpp (bits per pixel) in the present embodiment, but may also be recorded at other bit depths. In the present embodiment, data stored in the (A+B) image data section 308 and the A image data section 309 are set to uncompressed RAW image data which is not compressed. The present embodiment is not limited to this form, and may also be configured to store reversibly compressed RAW image data in the (A+B) image data section 308 and the A image data section 309 and to perform decompression processing of the compressed RAW image data at the time of reading.

An editing parameter section 310 is an area for recording parameters of editing processing. The parameters of editing processing are parameters when editing processing has been performed on the RAW image file 300 by the application 200 and the like in the past, and are configured to include an image editing parameter and an HDR combination parameter. The image editing parameter is, for example, a parameter of image editing processing executed by a user operating the editing operation area 240. In the present embodiment, the HDR combination parameter is set to a distinguishing flag which shows whether HDR combination processing has been performed on input RAW image data (hereinafter, referred to as an HDR combination flag). If the HDR combination flag is ON, this means that HDR combination processing has been executed. As the HDR combination parameter, a determination result for each pixel may also be used.

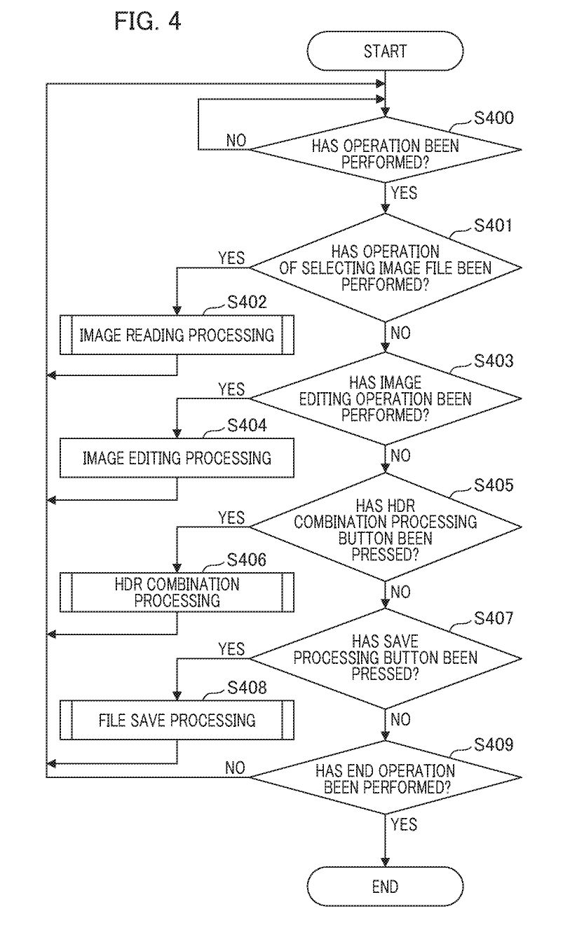

An operation of image processing and save processing according to the present embodiment will be described using FIGS. 4 to 8. In the present embodiment, an example in which a program for realizing processing of a flowchart is stored in the ROM 140 is shown, but the program may also be recorded in the storage medium 150 such as a memory card. If there is a program on a network, the present embodiment can be applied to a form in which the program is downloaded and executed. In the present embodiment, an example in which the application 200 operates on the PC 100 is shown, but the present embodiment can be applied to various types of processing device capable of performing the same processing as the application 200, for example, an imaging device and the like.

An operation of the application 200 including an HDR combination function and a file save function will be described with reference to the flowchart of FIG. 4. The HDR combination function is a function of performing an HDR combination on an input RAW image file. The file save function is a function of saving RAW image data after editing processing as an image file. In S400, the control unit 110 receives an operation instruction from a user. If an operation instruction of a user is detected, the procedure proceeds to processing of S401, and, if there is no operation instruction, the determination processing of S400 is repeated.

In S401, the control unit 110 determines whether an operation of selecting an input RAW image file has been performed by a user. The operation of selecting a file is performed, for example, by a user clicking one of folders displayed in the folder tree display area 210 and then clicking one of thumbnail images displayed in the thumbnail display area 220. If it is determined that the operation of selecting an input RAW image file has been performed, the procedure proceeds to processing of S402. In addition, if it is determined that an operation of selecting an input RAW image file has not been performed, the procedure proceeds to processing of S403.

In S402, the control unit 110 performs image reading processing. Details thereof will be described below. If the image reading processing ends, the control unit 110 returns to the processing of S400. In S403, the control unit 110 determines whether a GUI object of the editing operation area 240 has been operated by a user, that is, whether the image editing operation has been performed. If it is determined that the image editing operation has been performed, the procedure proceeds to processing of S404, and, if it is determined that an image editing operation has not been performed, the procedure proceeds to processing of S405.

In S404, the control unit 110 performs image editing processing in accordance with parameters or contents assigned to a GUI object operated in S403 on image data stored in the (A+B) image data section 308 of an input RAW image file. A result of image editing processing is presented to a user by being displayed in the preview area 230. If the image editing processing ends, the control unit 110 returns to the processing of S400. The image editing processing is not an essential matter of the present invention, and thus description will be omitted.

In S405, the control unit 110 determines whether the HDR combination processing button 241 has been pressed by a user. If it is determined that the HDR combination processing button 241 of FIG. 2 has been pressed, the procedure proceeds to processing of S406, and, if it is determined that the HDR combination processing button 241 has not been pressed, the procedure proceeds to processing of S407. In S406, the control unit 110 performs HDR combination processing. Details thereof will be described below. If the HDR combination processing ends, the control unit 110 returns the processing to S400.

In S407, the control unit 110 determines whether the save processing button 250 has been pressed by a user. If it is determined that the save processing button 250 of FIG. 2 has been pressed, the procedure proceeds to processing of S408, and, if the save processing button 250 has not been pressed, the procedure proceeds to processing of S409.

In S408, the control unit 110 performs file save processing. Details thereof will be described below. If the file save processing ends, the control unit 110 returns the processing to S400. In S409, the control unit 110 determines whether an end operation of the application 200 has been performed by a user. If it is determined that the end operation of the application 200 has been performed, the procedure ends the processing, and, if it is determined that the end operation of the application 200 has not been performed, the procedure returns the processing to S400.

In the operation described above, after the processing starts, S403 to S408 may also be skipped until an input RAW image file is selected in S401. Alternatively, a specific input RAW image file among RAW image files displayed in the thumbnail display area 220 may also be set as an initial input RAW image file. The specific input RAW image file may be, for example, a RAW image file having an order of a display position, a clip name, a photographing date and time, and the like at the beginning or at the end thereof, a RAW image file which has been subjected to previous image processing, or the like.

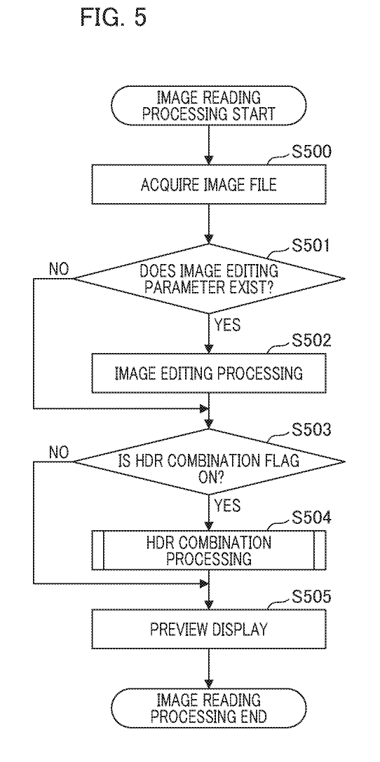

Next, with reference to a flowchart of FIG. 5, the image reading processing shown in S402 of FIG. 4 will be described. The control unit 110 in S500 acquires an input RAW image file selected by a user in S401 of FIG. 4 from the storage medium 150. The control unit 110 in S501 determines whether an image editing parameter exists. If it is determined that an image editing parameter is recorded in the editing parameter section 310 of the input RAW image file, the procedure proceeds to processing of S502, and, if it is determined that the image editing parameter has not been recorded, the procedure proceeds to processing of S503.

In S502, the control unit 110 executes the image editing processing. The image editing processing in accordance with an image editing parameter recorded in the editing parameter section 310 is performed on image data stored in the (A+B) image data section 308 of the input RAW image file. If the image editing processing ends, the procedure proceeds to the processing of S503.

In S503, the control unit 110 performs the determination processing of a HDR combination flag. If a HDR combination parameter exists in the editing parameter section 310 of the input RAW image file, and a determination condition in which the HDR combination flag is ON is satisfied, the procedure proceeds to the processing of S504. If the determination condition is not satisfied, the procedure proceeds to processing of S505. In S504, the control unit 110 performs HDR combination processing on the input RAW image file. Details thereof will be described below. If the HDR combination processing ends, the procedure proceeds to the processing of S505.

In S505, the control unit 110 performs preview display processing. After the image data of the display image data section 306 is acquired from the input RAW image file and processing of displaying the image data in the preview area 230 of FIG. 2 is performed, the image reading processing ends. The image data displayed in the preview area 230 may be image data generated using a result obtained by performing processing in S502 and S504.

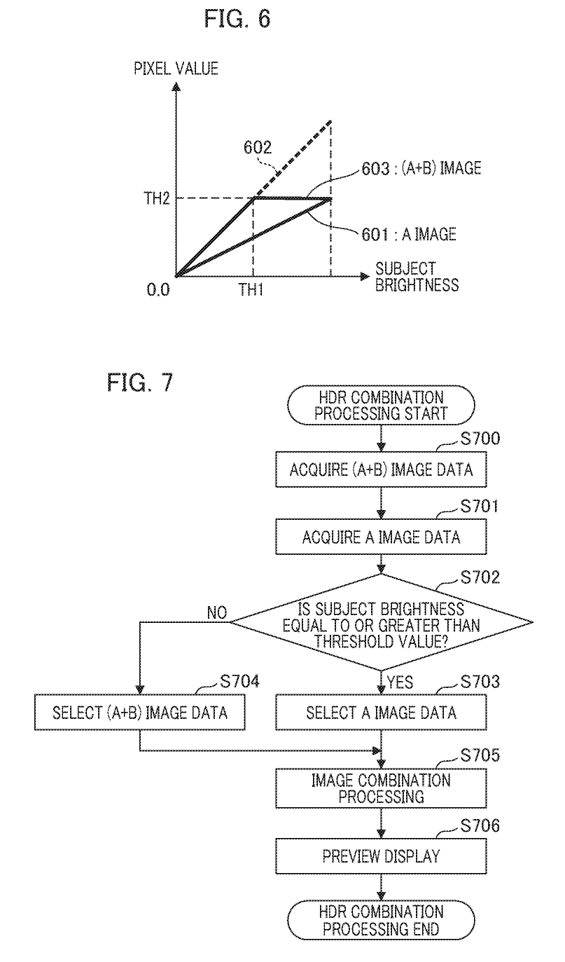

Next, with reference to FIGS. 6 and 7, the HDR combination processing in S406 of FIG. 4 and S504 of FIG. 5 will be described. In the HDR combination processing, with respect to the RAW image file 300 displayed in FIG. 3, processing of generating image data with an extended dynamic range and displaying the generated image data is executed.

FIG. 6 is a diagram which describes HDR combination processing. A vertical axis represents a pixel value, and a horizontal axis represents a brightness of a subject. A graph line 601 indicates a pixel value of the A image, and a graph line 603 indicates a pixel value of the (A+B) image. TH2 represents a saturation level of the pixel value. If a bright subject is imaged with an appropriate exposure, the pixel value is clipped at a level TH2. In the present embodiment, a bit depth of the (A+B) image is set to 14 bpp. TH2 corresponds to a maximum value of the pixel value which can be represented by 14 bits. TH1 is a brightness of the subject corresponding to a saturation level of appropriate exposure. A graph line 602 represents a pixel value of an A* image obtained by gaining up the A image by one stage. Since the A image is an image one stage under the (A+B) image, it is possible to match brightness to the (A+B) image using the A* image. In addition, it is possible to acquire a pixel value of 15 bpp as the A* image by gaining up the A image of 14 bpp by one stage. An upper limit of the pixel value of the A* image is twice the saturation level TH2, that is, “TH2×2”. The brightness of a subject can be represented by the pixel value of the A* image up to “TH1×2”.

With reference to a flowchart of FIG. 7, the HDR combination processing will be described. In S700, the control unit 110 acquires (A+B) image data from the (A+B) image data section 308 of an input RAW image file. In S701, the control unit 110 acquires A image data from the A image data section 309 of the input RAW image file. In S702, the control unit 110 determines whether the brightness of a subject image at a predetermined pixel position is equal to or greater than a threshold value (TH1). If the brightness of a subject image at a predetermined pixel position is equal to or greater than the threshold value, the procedure proceeds to processing of S703. If the brightness of a subject image at a predetermined pixel position is less than the threshold value, the procedure proceeds to the processing of S704.

In S703, from acquired A image data 601 and the (A+B) image data 603, the control unit 110 selects the A image data 601. In S704, the control unit 110 selects the (A+B) image data 603 from the acquired A image data 601 and the (A+B) image data 603. In S705, the control unit 110 performs processing of generating an HDR combined image on the basis of the image data selected in S703 and S704. The control unit 110 at this time gains up the A image data 601 at a pixel position at which the brightness of a subject image is equal to or greater than the threshold value to generate A* image data 602. In S706, the control unit 110 performs processing of displaying the HDR combined image generated in S705 in the preview area 230, and ends the HDR combination processing.

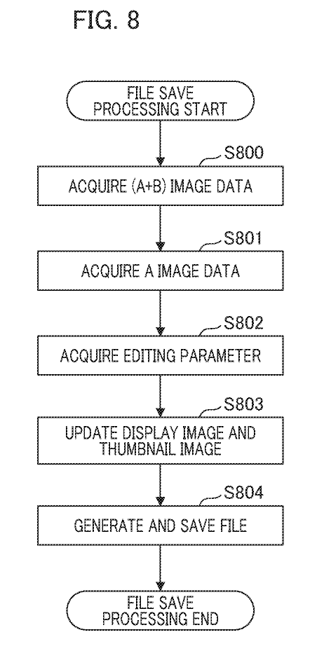

Next, file save processing shown in S408 of FIG. 4 will be described with reference to a flowchart of FIG. 8. A result of image processing by the application 200 is saved in a file format having the same configuration as the RAW image file 300.

In S800, the control unit 110 acquires (A+B) image data from the (A+B) image data section 308 of the input RAW image file. In S801, the control unit 110 acquires A image data from the A image data section 309 of the input RAW image file. In S802, the control unit 110 acquires editing parameters. The editing parameters are as follows.

Parameters acquired from the editing parameter section 310 of an input RAW image file,

Parameters of image editing processing executed in S404 of FIG. 4, and

HDR combination parameters of HDR combination processing executed in S406 of FIG. 4.

In S803, the control unit 110 performs processing of generating a display image and a thumbnail image using a result of the image editing processing in S404 of FIG. 4. In S804, the control unit 110 generates information on an IFD section for each piece of data acquired in S800 to S803, saves the information in a format of the RAW image file 300 of FIG. 3 in the storage medium 150, and ends the file save processing. At this time, an input RAW image file is overwritten and saved in the present embodiment. However, a user can select whether to overwrite and save the input RAW image file or to save this as another file.

In the present embodiment, a result of performing HDR combination processing on the RAW image file configured from the (A+B) image and the A image can be saved as a RAW image file having the same configuration as an original file. In addition, the result of HDR combination processing is saved in the same file format as the input RAW image file, and thereby image editing using the application 200 is possible again. According to the present embodiment, it is possible to provide an image processing device which is advantageous in saving HDR image data generated by performing HDR combination processing on a plurality of image data each having a different viewpoint acquired from one instance of photographing in a storage medium in a predetermined file format.

### Second Embodiment

Next, a second embodiment of the present invention will be described. In the present embodiment, an example in which a user can select a format of a RAW image file to be saved from a plurality of different file formats will be described. A block diagram showing a configuration of a PC, a UI configuration diagram of the application 200, and a conceptual diagram of a RAW image file stored in the storage medium 150 in the present embodiment are the same as in FIGS. 1A to 3 of the first embodiment, respectively. Accordingly, descriptions thereof will be omitted and mainly differences will be described. Such omission of description is the same as in embodiments to be described below.

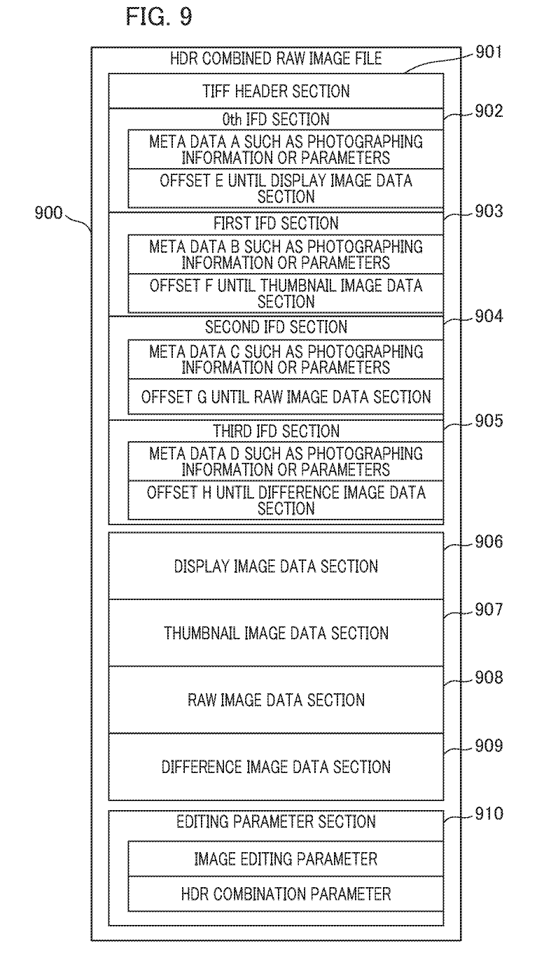

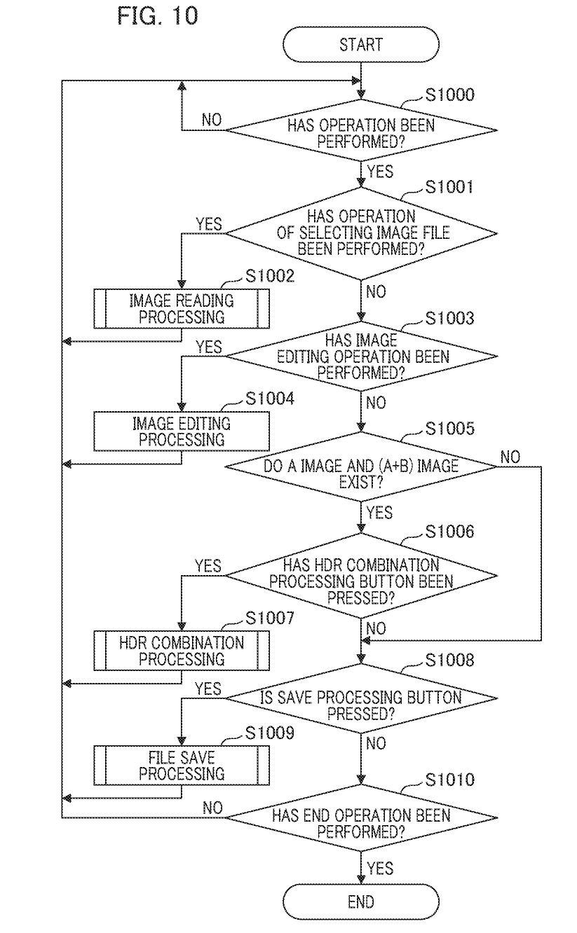

With reference to FIGS. 9 and 10, the imaging processing and the save processing according to the present embodiment will be described. FIG. 9 is a conceptual diagram which shows a data structure of an HDR combined RAW image file 900 having a RAW image data section and a difference image data section. The RAW image file 900, like the RAW image file 300, has a data structure of an image file conforming to the TIFF format. Areas 901 to 903, 906 to 907, and 910 correspond to 301 to 303, 306 to 307, and 310 of FIG. 3, and thus description thereof will be omitted.

A RAW image data section 908 is an area for storing a single piece of RAW image data. In the present embodiment, a bit depth of the RAW image data is set to 14 bpp or 15 bpp. A difference image data section 909 is an area for storing difference image data generated by file save processing. Details of data contents will be described below. In addition, the difference image data section 909 does not necessarily exist.

IFD sections 904 and 905 are IFD sections corresponding to the RAW image data section 908 and the difference image data section 909, respectively. In the second IFD section 904, information on the bit depth of RAW image data stored in the RAW image data section 908 is also recorded.

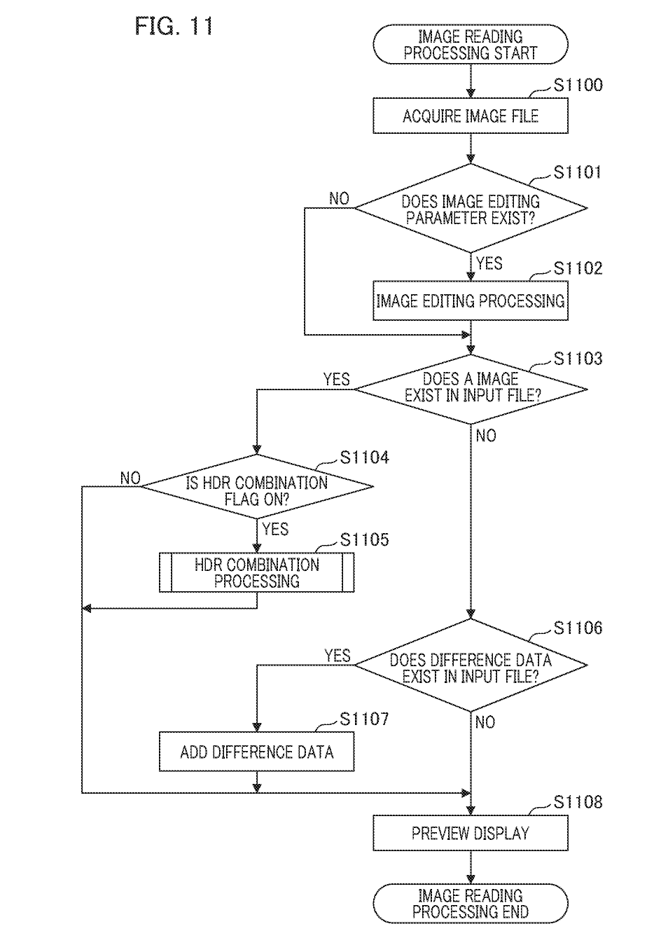

Next, the image processing and the file save processing according to the present embodiment will be described with reference to FIGS. 10 and 11. FIG. 10 is a flowchart which describes an operation of the application 200 including the HDR combination function and the file save function. The HDR combination function is a function for performing HDR combination on an input RAW image file. The file save function is a function for saving an edited RAW image file as an image file in a format in accordance with a selection of a user. Processing S1000 to S1004 is the same as processing S400 to S404 of FIG. 4, respectively, and thus descriptions thereof will be omitted.

In S1005, the control unit 110 searches for information on an IFD section of an input RAW image file, and determines whether both the (A+B) image data section 308 and the A image data section 309 exist in the input RAW image file. If the (A+B) image data section 308 and the A image data section 309 exist, the procedure proceeds to processing of S1006, and, if the (A+B) image data section 308 and the A image data section 309 do not exist, the procedure proceeds to processing of S1008. Processing of S1006 to S1010 is the same as processing of S405 to S409 of FIG. 4, and thus descriptions thereof will be omitted.

Next, specific image reading processing of the present embodiment in S1002 of FIG. 10 will be described with reference to a flowchart of FIG. 11. Processing of S1100 to S1102 is the same as processing of S500 to S502 of FIG. 5, and thus descriptions thereof will be omitted.

In S1103, the control unit 110 searches for information on an IFD section of an input RAW image file, and determines whether the A image data section 309 exists in the input RAW image file. If it is determined that the A image data section 309 exists in the input RAW image file, the procedure proceeds to HDR combination flag determination processing of S1104. If it is determined that the A image data section 309 does not exist in the input RAW image file, the procedure proceeds to processing of S1106. The processing of S1104 and S1105 is the same as processing of S503 to S504 of FIG. 5, and thus descriptions thereof will be omitted.

In S1106, the control unit 110 searches for information on an IFD section of an input RAW image file, and determines whether the difference image data section 909 exists in the input RAW image file. If it is determined that the difference image data section 909 exists in the input RAW image file, the procedure proceeds to processing of S1107, and, if it is determined that the difference image data section 909 does not exist in the input RAW image file, the procedure proceeds to processing of S1108.

In S1107, the control unit 110 adds difference image data of the difference image data section 909 to image data of the RAW image data section 908. In S1108, the control unit 110 acquires the image data of the display image data section 306 from the input RAW image file to display the data in the preview area 230, and ends the image reading processing. The image data displayed in the preview area 230 may also be image data generated using a result of performing processing in S1102, S1105, and S1107.

The HDR combination processing in S1007 of FIG. 10 and S1105 of FIG. 11 is the same as the processing described in FIG. 6 and FIG. 7, and thus descriptions thereof will be omitted.

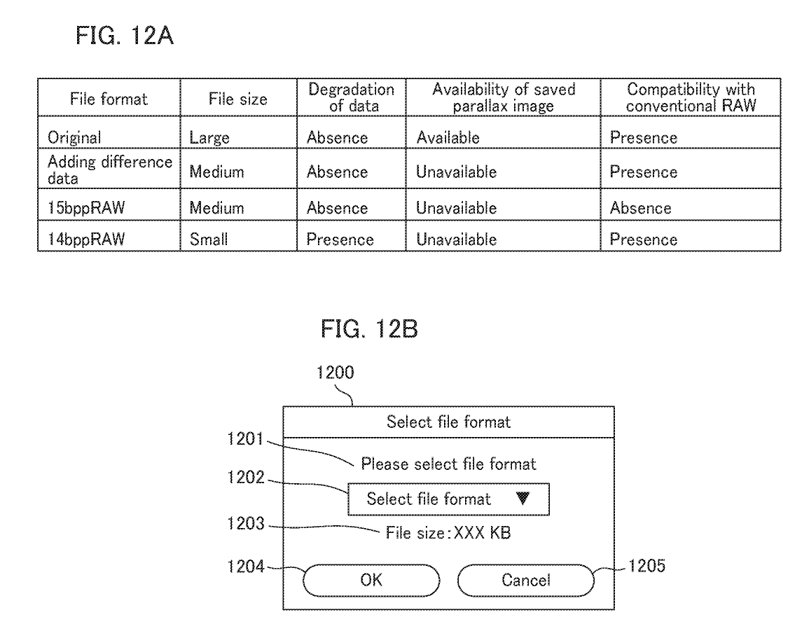

Next, file save processing in S1009 of FIG. 10 will be described with reference to FIGS. 12A to 14. In the file save processing, processing of saving a result of the image processing by the application 200 in a file format having the same configuration as any one of the RAW image file 300 and the HDR combined RAW image file 900 according to a selection of a user is performed.

FIGS. 12A and 12B are diagrams for describing the file save processing. FIG. 12A is a list of file formats which can be selected by a user in the file save processing. For four file formats, file size, degradation of data, availability of saved parallax images, and presence or absence of compatibility are exemplified, respectively. Information in a file format is displayed on the screen of the display unit 170 and presented to a user. In FIG. 12A, file size information, compatibility information, and information on image quality change caused by lost data are exemplified as information in a file format of output image data, but other types of information can be used. The file format is “original”, “adding difference data”, “15 bpp RAW”, and “14 bpp RAW”.

FIG. 12B shows an example of a UI configuration of the file format selection dialog 1200 for a user to select a file format in the file save processing. A message 1201 prompting a user to select a file format is displayed in the dialog 1200. A list for selecting a file format by a user's click is displayed in a drop-down list 1202 under the message. If a user clicks the drop-down list 1202, names of a plurality of file formats shown in FIG. 12A are displayed in a list format. A user can select a desired file format by a drag-and-drop operation. It is assumed that any file format is not selected for an initial state of the drop-down list 1201 when the dialog 1200 is displayed. A default state may be a state in which a top file format in the list is selected, or may be a state in which the same file format is selected as when the file save processing has been previously performed is selected. An area 1203 is an area for displaying a predicted value of the size of a saved file on the basis of a file format selected by a user operating the drop-down list 1202. A numerical value of a file size is updated whenever a selection state of the drop-down list 1202 changes. An OK button 1204 is an operation area for instructing execution of the file save processing by a user's click. A cancel button 1205 is an area for instructing cancellation of the file save processing by a user's click, and making it possible to return to a previous screen. In addition, the file format selection dialog 1200 includes an area for displaying a description of the information shown in FIG. 12A, an area for selecting a saving location of a file, and an area for changing a name of a file or extension for the selected file format.

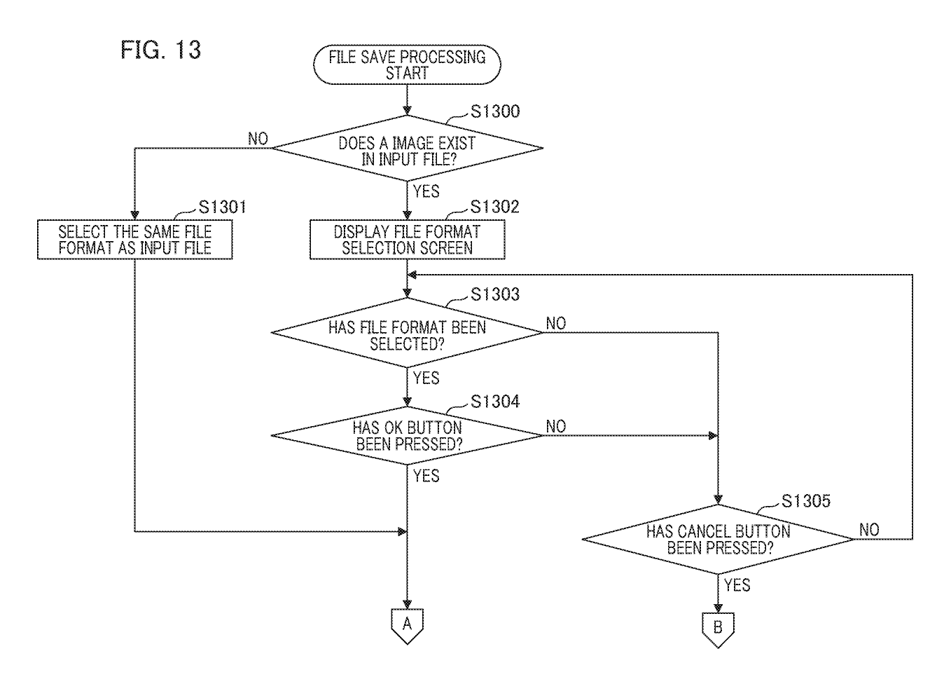

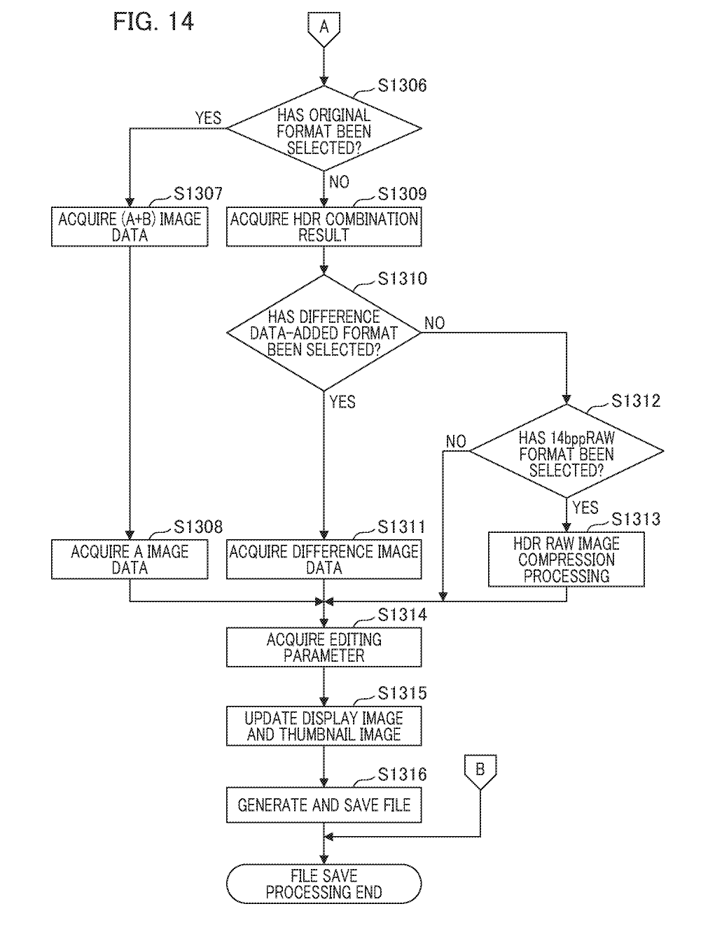

FIGS. 13 and 14 show flowcharts which describe the file save processing. In S1300, the control unit 110 searches for information on an IFD section of an input RAW image file, and determines whether the A image data section 309 exists in the input RAW image file. If it is determined that the A image data section 309 exists in the input RAW image file, the procedure proceeds to processing of S1302, and, if the A image data section 309 does not exist, the procedure proceeds to the processing of S1301.

In S1301, the control unit 110 selects the same file format as the input RAW image file, and proceeds to processing of S1306 of FIG. 14. In addition, in S1302, the control unit 110 performs processing of displaying the file format selection dialog 1200 shown in FIG. 12B on the screen of the display unit 170. In S1303, the control unit 110 determines whether any of file formats shown in FIG. 12A have been selected in the drop-down list 1202 of the file format selection dialog 1200. If a file format has been selected, the procedure proceeds to processing of S1304, and, if a file format has not been selected, the procedure proceeds to processing of S1305.

In S1304, the control unit 110 determines whether the OK button 1204 of FIG. 12B has been pressed by a user. If the OK button 1204 has been pressed, the procedure proceeds to the processing of S1306 of FIG. 14, and, if the OK button 1204 has not been pressed, the procedure proceeds to the processing of S1305. In S1305, the control unit 110 determines whether the cancel button 1205 of FIG. 12B has been pressed. If the cancel button 1205 of FIG. 12B has been pressed by a user, the procedure ends the file save processing, and, if the cancel button has not been pressed, the procedure proceeds to the processing of S1303.

In S1306 of FIG. 14, the control unit 110 determines whether an “original” file format has been selected in the drop-down list 1202 of the file format selection dialog 1200. If the “original” file format has been selected, the procedure proceeds to processing of S1307, and, if the “original” file format has not been selected, the procedure proceeds to processing of S1309. Processing of S1307 and S1308 is the same as the processing of S800 and S801 of FIG. 8, respectively, and thus descriptions thereof will be omitted.

In S1309, the control unit 110 acquires HDR combined images obtained by the HDR combination processing in S406 of FIG. 4. The HDR combination image data is 15 bpp image data. In S1310, the control unit 110 determines whether a difference data-added file format has been selected in the drop-down list 1202 of the file format selection dialog 1200. If the difference data-added file format has been selected, the procedure proceeds to processing of S1311, and, if the difference data-added file format has not been selected, the procedure proceeds to processing of S1312.

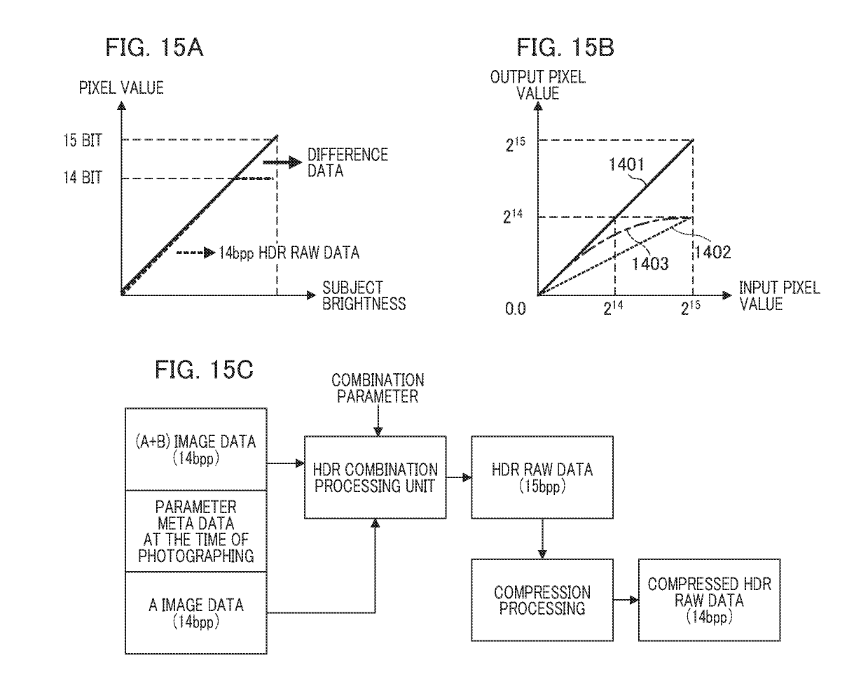

In S1311, the control unit 110 acquires difference image data. The difference image data is obtained by subtracting an image obtained by clipping an HDR combined image at 14 bpp from the HDR combined image acquired in S1309. In the present embodiment, the difference image data is the same as 1 bpp image data represented by a highest-order bit of A image data. FIG. 15A is a diagram which describes 14 bpp HDR RAW image data and difference image data. A horizontal axis represents a brightness of a subject and a vertical axis represents a pixel value.

In S1312, the control unit 110 determines whether a 14 bpp RAW file format has been selected in the drop-down list 1202 of the file format selection dialog 1200. If the “14 bpp RAW” file format has been selected, the procedure proceeds to processing of S1313, and, if the “14 bpp RAW” file format has not been selected, that is, if a “15 bpp RAW” file format has been selected, the procedure proceeds to processing of S1314.

In S1313, the control unit 110 performs HDR RAW image compression processing. The HDR RAW image compression processing is processing of converting a 15 bpp HDR combined image into 14 bpp data. Details thereof will be described below. If the HDR RAW image compression processing ends, the procedure proceeds to the processing of S1314. Processing of S1314 to S1316 is the same as the processing of S802 to S804 of FIG. 8, and thus descriptions thereof will be omitted.

FIG. 15B is a diagram for describing the HDR Raw image compression processing in S1313 of FIG. 14. A vertical axis represents a pixel value in output image data of the HDR RAW image compression processing, and a horizontal axis represents a pixel value in input image data. A graph line 1401 indicates an output pixel value when the HDR RAW compression processing is not performed. An output pixel value indicated by the graph line 1401 is the same as an output pixel value when the 15 bpp RAW file format is selected in the present embodiment. FIG. 15C is a conceptual diagram which shows a flow of processing of generating 14 bit compression data. An HDR combination processing unit acquires (A+B) image data and A image data, and parameters at the time of photographing, and executes combining processing according to a combination parameter. The generated 15 bpp RAW data is subjected to compression processing, and thereby 14 bpp HDR RAW data is obtained.

A graph line 1402 of FIG. 15B indicates an output pixel value when an input pixel value of 15 bits (0 to 32768) is mapped to a range of 14 bits (0 to 16384). For the mapping, a method of taking out a value corresponding to each pixel with reference to a correspondence table between an input pixel value and an output pixel value held by the application 200 is used. The application 200 may hold a plurality of corresponding tables and use them according to input image data. For example, in the case of an overall dark image, gradation of a low brightness portion can be left by assigning more values of an output pixel value to a small range of an input pixel value as shown in the graph line 1402. Moreover, a corresponding table is added for an editing parameter acquired in S1314 of FIG. 14, and thereby, when a saved file is reloaded to the application 200, it is possible to convert the file into data close to original HDR combination image data by inverse conversion.

In addition, a method of compressing a file to 14 bpp by setting the pixel values indicated by the graph line 1401 to output pixel values gained down by one stage like pixel values represented by a graph 1403 may also be used. In this case, data of contents gained-up by one stage is added to the editing parameters acquired in S1314 of FIG. 14, and thereby it is possible to adjust brightness to the original HDR combination image data when the saved file is reloaded to the application 200.

According to the present embodiment, a result of performing the HDR combination processing on the RAW image file constituted by the (A+B) image and the A image can be saved as a RAW image file of a format selected by a user.

### Third Embodiment

Next, a third embodiment of the present invention will be described. In the present embodiment, an example in which the HDR combination processing is performed on a RAW image file constituted by an A image and a B image is shown. In the first embodiment, an example in which a file format selection dialog is necessarily displayed at the time of executing the file save processing is described. On the other hand, in the present embodiment, an example in which, if a file format is selected once, an operation of selecting a file format is not necessary whenever the file save processing is executed is shown.

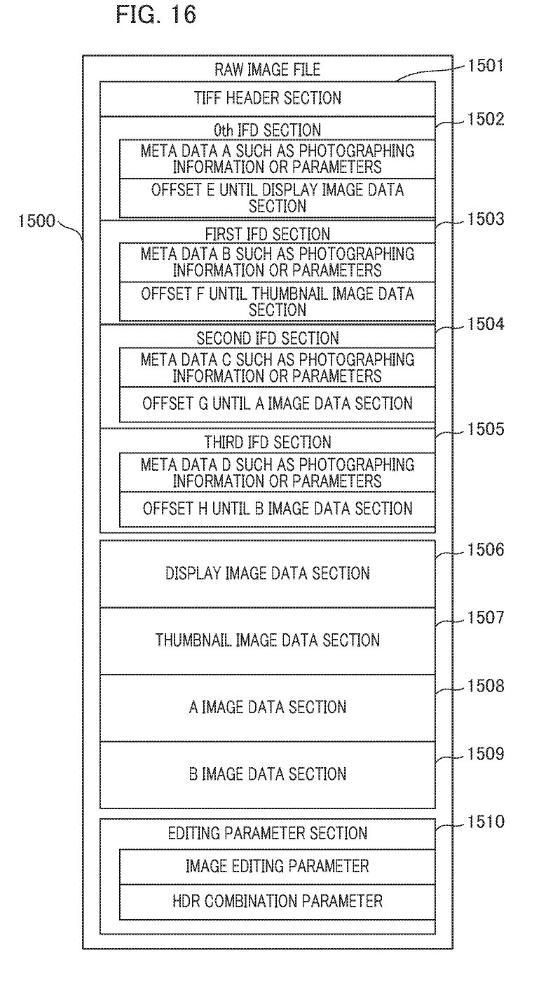

FIG. 16 is a conceptual diagram of a RAW image file 1500 stored in the storage medium 150. The Raw image file 1500, like the RAW image file 300, has a structure of an image file conforming to the TIFF format, and an image data section has an A image data section and a B image data section. Areas 1501 to 1503, 1506 to 1507, and 1510 correspond to the areas 301 to 303, 306 to 307, and 310 of FIG. 3, respectively, and thus descriptions thereof will be omitted.

Each of the A image data section 1508 and the B image data section 1509 is an area for storing RAW image data recorded by an imaging device capable of acquiring pupil-divided images. Specifically, the imaging device described in the first embodiment generates each piece of data of a pupil-divided image (A image) of a first pixel and a pupil-divided image (B image) of a second pixel. The imaging device records the A image subjected to shading correction in the A image data section 1508 of the RAW image file 1500, and records the B image subjected to shading correction in the B image data section 1509. At this time, with respect to an (A+B) image obtained by adding the A image to the B image, the A image and the B image have a pixel aperture underexposed by one stage, and thus the (A+B) image is an appropriately exposed image, and the A image and the B image are underexposed images. The IFD sections 1504 and 1505 are IFD sections corresponding to the A image data section 1508 and the B image data section 1509, respectively.

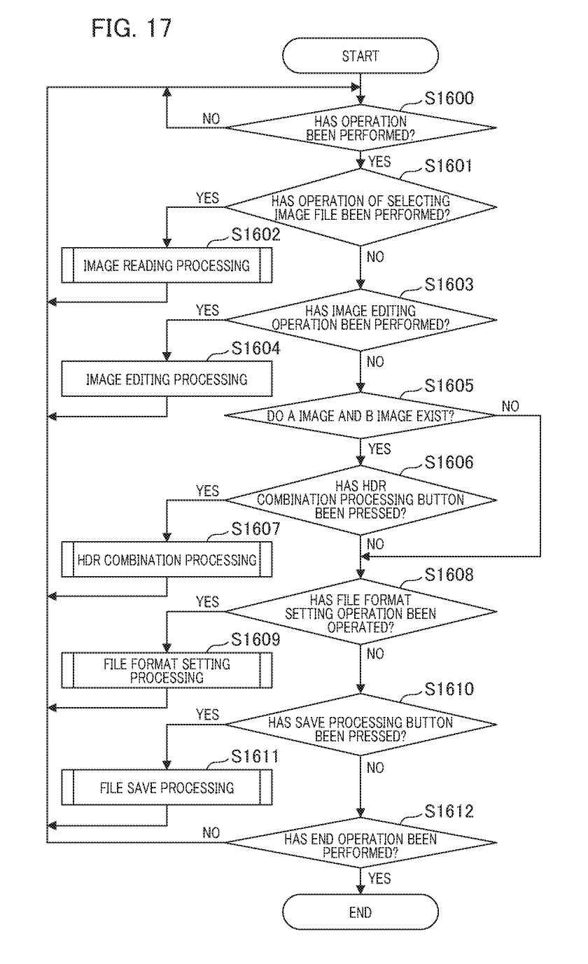

Next, image processing and save processing according to the present embodiment will be described with reference to FIGS. 17 to 20. FIG. 17 is a flowchart which describes an operation of the application 200 including an HDR combination function and a file save function. The HDR combination function is a function for performing HDR combination on an input RAW image file. The file save function is a function for saving an edited Raw image file in a file format set in advance. Processing of S1600 to S1604 is the same as the processing of S1000 to S1004 of FIG. 10, and thus descriptions thereof will be omitted.

In S1605, the control unit 110 searches for information on an IFD section of an input RAW image file, and determines whether both the A image data section 1508 and the B image data section 1509 exist in the input RAW image file. If it is determined that both the A image data section 1508 and the B image data section 1509 exist in the input RAW image file, the procedure proceeds to processing of S1606. If it is determined that both the A image data section 1508 and the B image data section 1509 do not exist in the input RAW image file, the procedure proceeds to processing of S1608. The processing of S1606 is the same as the processing of S1006 of FIG. 10, and thus description thereof will be omitted.

In S1607, the control unit 110 performs HDR combination processing. In the present embodiment, the HDR combination processing is processing of generating (A+B) image data by adding data acquired from the A image data section 1508 and the B image data section 1509 of the input image file, and displaying the (A+B) image data in the preview area 230. Each of A image data and B image data is a 14 bpp image underexposed by one stage, and thus the (A+B) image data obtained by adding these pieces of image data is an appropriately exposed image of 15 bpp, and has a pixel value corresponding to a brightness of a subject the same as in the graph line 602 of FIG. 6.

In S1608, the control unit 110 determines whether a setting button 251 of a file format has been pressed by a user. If it is determined that the setting button 251 has been pressed, the procedure proceeds to processing of S1609, and, if it is determined that the setting button 251 has not been pressed, the procedure proceeds to processing of S1610. In S1609, the control unit 110 performs file format setting processing. Details thereof will be described below. If the file format setting processing ends, the procedure returns to the processing of S1600. Processing in S1610 and S1612 is the same as the processing in S1008 and S1010 of FIG. 10, and thus descriptions thereof will be omitted.

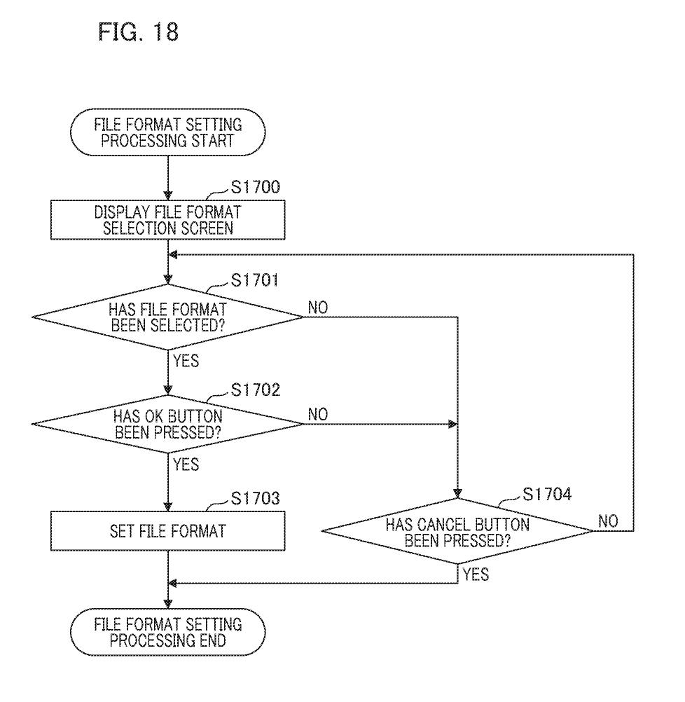

Next, the file format setting processing in S1609 of FIG. 16 will be described with reference to a flowchart of FIG. 18. Processing in S1700 to S1702 is the same as the processing in S1302 to S1304 of FIG. 13, and thus descriptions thereof will be omitted.

In S1703, the control unit 110 sets a file format selected in the drop-down list 1202 of the file format selection dialog 1200 as setting information of the application 200 and records the file format in the memory 130. The setting information of a file format is recorded in the ROM 140 at the time of ending the application 200 and is read at the time of starting the application 200 again, and thus the same setting can be used again. The setting information of a file format maybe stored in the ROM 140 at the time of S1703, maybe cancelled at the time of ending the application 200, and an initial value may be used at the time of starting the application 200 again. The initial value of the setting information of a file format is set to an “original” format. If the setting information of a file format is not set, S1610 of FIG. 17 may be skipped by invalidating the save processing button 250.

In S1704, the control unit 110 determines whether the cancel button 1205 has been pressed by a user. If it is determined that the cancel button 1205 has been pressed, the procedure ends the file format setting processing, and, if the cancel button 1205 has not been pressed, the procedure returns to processing of S1701.

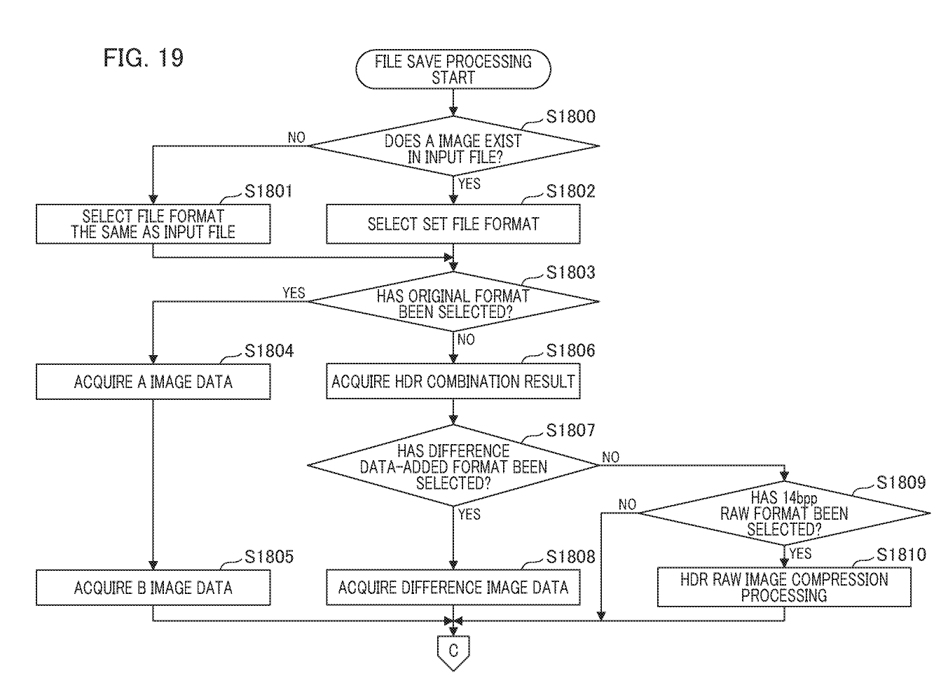

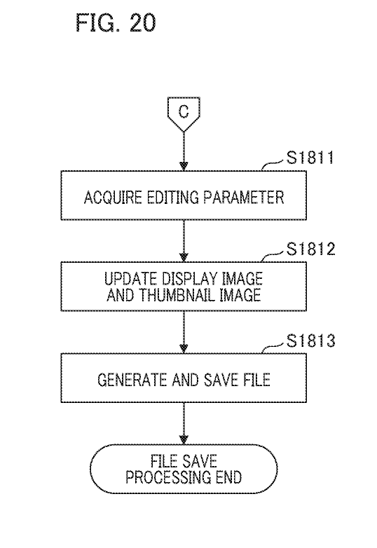

Next, the file save processing shown in S1611 of FIG. 17 will be described with reference to flowcharts of FIGS. 19 and 20. Processing of S1800 and S1801 is the same as the processing of S1300 and S1301 of FIG. 13, and thus descriptions thereof will be omitted.

In S1802, the control unit 110 selects a file format set in S1609 of FIG. 17. The control unit 110 in S1803 determines whether an “original” file format has been selected in S1601 or S1602. If it is determined that the “original” file format has been selected, the procedure proceeds to processing of S1804, and, if the “original” file format has not been selected, the procedure proceeds to processing of S1806.

In S1804, the control unit 110 acquires A image data from the A image data section 1508 of an input RAW image file. In S1805, the control unit 110 acquires B image data from the B image data section 1509 of an input RAW image file. Processing of S1806 to S1813 of FIGS. 19 and 20 is the same as the processing of S1309 to S1316 of FIG. 13, and thus descriptions thereof will be omitted.

According to the present embodiment, a result of performing the HDR combination processing on a RAW image file constituted by an A image and a B image can be saved as a RAW image file in a format selected by a user. In addition, an application holds a result of selecting a file format by a user once, and thereby it is not necessary to perform an operation of selecting a file format whenever the file save processing is executed and file save in a desired file format is performed.

Although the present invention has been described in detail on the basis of preferred embodiments thereof, the present invention is not limited to these specific embodiments, and various modes in a range not departing from the gist of the present invention are included in the present invention. Some of the embodiments described above may be appropriately combined.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium such that they perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like,

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-253249, filed Dec. 27, 2016, which is hereby incorporated by reference wherein in its entirety.

What is claimed is:

1. An image processing device comprising,
a memory storing instructions and
a processor which is capable of executing the instructions causing the image processing device to:
acquire a plurality of viewpoint image data each having a different viewpoint as input image data;
perform combining processing related to dynamic range extension on the input image data and generate output image data; and
save the output image data or the viewpoint image data and the output image data in a predetermined file format as a file in a storage medium.

2. The image processing device according to claim 1,
wherein the input image data is viewpoint image data acquired from one instance of photographing and is RAW image data before image processing is performed.

3. The image processing device according to claim 1,
wherein the input image data includes first image data acquired from a first photoelectric conversion unit and second image data obtained by adding the first image data to image data acquired from a second photoelectric conversion unit, wherein the first and second photoelectric conversion units respectively receive light passing through different pupil areas of an imaging optical system and
wherein, the first image data is saved in a first area of the file and the second image data is saved in a second area of the file.

4. The image processing device according to claim 1,
wherein the input image data is image data of first image data acquired from a first photoelectric conversion unit and second image data acquired from a second photoelectric conversion unit, wherein the first and second photoelectric conversion units respectively receive light passing through different pupil areas of an imaging optical system, and
wherein the first image data is saved in a first area of the file and the second image data is saved in a second area of the file.

5. The image processing device according to claim 1,
wherein the output image data is saved in a file format of the input image data.

6. The image processing device according to claim 2,
wherein the RAW image data is saved in a first area of the file and different image data is saved in a second area of the file.

7. The image processing device according to claim 1, wherein the instructions further cause the image processing device to:
select one of a plurality of file formats,
wherein the output image data is saved in a selected file format.

8. The image processing device according to claim 7, wherein the instructions further cause the image processing device to:
display information in the plurality of file formats,
wherein the file format information contains one or more of file size information, compatibility information, and information, on a change in image quality for a file in which the output image data is saved.

9. The image processing device according to claim 1,
Wherein the instructions further cause the image processing device to add information to the output image data indicating that combining processing has been performed.

10. An imaging device including an image processing device and an imaging element for imaging a subject,
wherein the image processing device comprises
a memory storing instructions and
a processor which is capable of executing the instructions causing the image processing device to:
acquire a plurality of image data each having a different viewpoint as input image data,
perform combining processing related to dynamic range extension on the input image data and generate output image data, and
save the output image data or the viewpoint image data and the output image data in a predetermined file format as a file in a storage medium.

11. The imaging device according to claim 10,
wherein the imaging element includes a plurality of microlenses and a plurality of photoelectric conversion units, each microlens respectively corresponds to the plurality of photoelectric conversion units, and
the plurality of image data each having a different viewpoint is generated from signals output by the plurality of photoelectric conversion units corresponding to each of the microlenses.

12. An image processing method executed by an image processing device which processes a plurality of image data each having a different viewpoint, the method comprising:
acquiring the viewpoint image data as input image data;
performing combining processing related to dynamic range extension on the input image data and generating output image data; and
saving the output image data or the viewpoint image data and the output image data in a predetermined file format as a file in a storage medium.

13. A non-transitory storage medium on which is stored a computer program for making a computer execute a method for controlling an image processing device, the method comprising:
acquiring the viewpoint image data as input image data;
performing combining processing related to dynamic range extension on the input image data and generating output image data; and
saving the output image data or the viewpoint image data and the output image data in a predetermined file format as a file in a storage medium.
